(19) United States
(12) Patent Application Publication
(10) Pub. No.: US 2013/0314395 A1
(43) Pub. Date: Nov. 28, 2013

(54) PIXEL VALUE ADJUSTING METHOD AND IMAGE DISPLAY SYSTEM UTILIZING THE SAME

(71) Applicant: InnoLux Corporation, Miao-Li County (TW)

(72) Inventors: Bo-Chin TSUEI, Miao-Li County (TW); Yao-Lien HSIEH, Miao-Li County (TW); Mao-Nan LEE, Miao-Li County (TW); Chin- Yi TU, Miao-Li County (TW)

(73) Assignee: InnoLux Corporation, Miao-Li County (TW)

(21) Appl. No.: 13/898,684

(22) Filed: May 21, 2013

(30) Foreign Application Priority Data
May 24, 2012 (TW) 101118466

(51) Int. Cl. G09G 3/36

(52) U.S. Cl. CPC G09G 3/3611
USPC 345/212; 345/204; 345/84

(57) ABSTRACT

An image display system includes a data driving circuit and a timing controller. The data driving circuit outputs multiple data driving signals to provide data of an image signal to multiple pixels on a pixel array. The timing controller obtains original pixel values of the pixels according to the image signal, adjusts the original pixel value(s) of one or more pixel(s) according to a predetermined algorithm to generate adjusted pixel value(s), and generates the data driving signals according to the original pixel values and the adjusted pixel value(s). Based on the predetermined algorithm, an original pixel value of a pixel is adjusted according to a difference between the original pixel value of the pixel and an original pixel value of an adjacent pixel.

### CROSS REFERENCE TO RELATED APPLICATIONS

This Application claims priority of Taiwan Patent Application No. 101118466, filed on May 24, 2012, the entirety of which is incorporated by reference herein.

### BACKGROUND OF THE INVENTION

1. Field of the Invention

The invention relates to a pixel value adjusting method, and more particularly, to a pixel value adjusting method capable of compensating for MURA effect generated when performing line inversion.

2. Description of the Related Art

A liquid crystal display (LCD) device includes an LCD panel formed with multiple liquid crystal cells. A pixel element on an LCD panel includes a thin film transistor (TFT) electrically coupled with the liquid crystal cell. The pixel elements are substantially arranged in the form of a matrix having a plurality of pixel rows and a plurality of pixel columns. Typically, gate driving signals are sequentially applied to the plurality of pixel rows to sequentially turn on the pixel elements row-by-row. When a gate driving signal is applied to a pixel row to turn on corresponding TFTs of the pixel elements of a pixel row, source driving signals (i.e., image signals) for the pixel row are simultaneously applied to the plurality of pixel columns so as to charge a corresponding liquid crystal capacitor in the liquid crystal cell to control light transmittance therethrough. By repeating the procedure for all pixel rows, all pixel elements are supplied with corresponding source driving signals of the image signal, thereby displaying the image signal thereon.

It is known that if a substantially high voltage potential is applied in the liquid crystal layer for a long period of time, the optical transmission characteristics of the liquid crystal molecules may change. The change may be permanent, causing irreversible degradation in the display quality of the LCD. In order to prevent the LC molecules from deteriorating, an LCD device is usually driven by techniques that alternate the polarity of the voltages applied across a liquid crystal cell. The techniques may include inversion schemes such as frame inversion, row inversion, column inversion, and dot inversion.

Typically, coupling (electronics) for dot inversion is balanced. However, because the polarity of the voltage has to be alternated for each pixel, the power consumption when applying dot inversion is large. Meanwhile, column inversion consumes less power, but coupling for dot inversion is unbalanced. The performance for line inversion is somewhere between dot inversion and column inversion and therefore, line inversion has become a most commonly used driving technique. However, for the case where a pure color image is required to be displayed, pixel voltages may drift due to the voltage changes on the adjacent data lines when performing the line inversion, causing some lines to undesirably become darker or brighter than it should be. This is called the MURA effect.

Therefore, a pixel value adjusting method capable of compensating for MURA effect generated when performing the line inversion is highly required.

### BRIEF SUMMARY OF THE INVENTION

An image display system and pixel value adjusting method are provided. An exemplary embodiment of an image display system comprises a data driving circuit and a timing controller. The data driving circuit outputs a plurality of data driving signals to provide data of an image signal to a plurality of pixels on a pixel array. The timing controller obtains original pixel values of the pixels according to the image signal, adjusts the original pixel value(s) of one or more pixel(s) according to a predetermined algorithm to generate one or more adjusted pixel value(s), and generates the data driving signals according to the original pixel values and the adjusted pixel value(s). Based on the predetermined algorithm, the original pixel value of one pixel is adjusted according to a difference between the original pixel value of the pixel and the original pixel value of an adjacent pixel.

An exemplary embodiment of a pixel value adjusting method for compensating for MURA effect caused by performing line inversion comprises: receiving an image signal and obtaining original pixel values of a plurality of pixels on a pixel array according to the image signal; adjusting the original pixel value(s) of one or more pixels according to a predetermined algorithm to generate one or more adjusted pixel value(s); and generating a plurality of data driving signals according to the original pixel values and the adjusted pixel value(s) to provide data of the image signal to the pixel array, wherein a voltage polarity of the data driving signals is inverted once every N rows, and wherein 0<N<M, N is a positive integer and M is a number of the rows on the pixel array, and wherein based on the predetermined algorithm, the original pixel value of one pixel is adjusted according to a difference between the original pixel value of the pixel and the original pixel value of an adjacent pixel.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows one of the various types of image display systems of the invention according to an embodiment of the invention;

FIG. 2a shows an exemplary spatial voltage polarity distribution of a 3×6 pixel array according to an embodiment of the invention;

FIG. 2b shows two different exemplary gate line scan orders according to an embodiment of the invention;

FIG. 3 shows the voltage drift results caused by N-line inversion;

FIG. 4a˜4c shows different voltage distribution results caused by different scan orders according to an embodiment of the invention;

FIG. 5a shows an exemplary compensation table according to an embodiment of the invention;

FIG. 5b shows an exemplary compensation table according to another embodiment of the invention;

FIG. 6a is a diagram showing an original voltage difference V_{LC} and the final voltage difference V″_{LC} on a data line without compensating for MURA effect;

FIG. 6b is a diagram showing voltage distribution on a data line without compensating for MURA effect;

FIG. 7a is a diagram showing adjusting of a voltage difference V′_{LC} and the final voltage difference V″_{LC} on a data line after compensating for MURA effect according to an embodiment of the invention;

FIG. 7b is a diagram showing voltage distribution on a data line after compensating for MURA effect according to an embodiment of the invention; and

FIG. 8 shows a flow chart of a pixel value adjusting method for compensating for MURA effect caused by performing line inversion according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

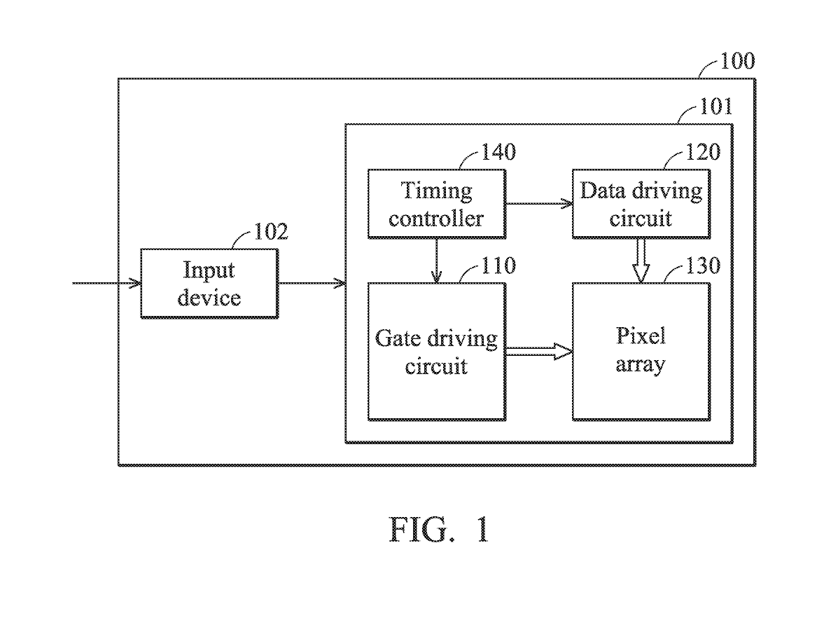

FIG. 1 shows one of the various types of image display systems of the invention according to an embodiment of the invention. As shown in FIG. 1, the image display system may comprise a display panel 101, where the display panel 101 may comprise a gate driving circuit 110, a data driving circuit 120, a pixel array 130 and a timing controller 140. The gate driving circuit 110 outputs a plurality of gate driving signals to drive a plurality of pixels on the pixel array 130. The data driving circuit 120 outputs a plurality of data driving signals to provide data to the pixels of the pixel array 130. The timing controller 140 may be a controller chip for receiving an image signal from a host (not shown), processing the image signal, generating a plurality of gate driving signals and/or data driving signals, and generating a plurality of timing signals, comprising clock signals, reset signals and start pulses.

In addition, the image display system of the invention may further be comprised in an electronic device 100. The electronic device 100 may comprise the above-mentioned display panel 101 and an input device 102. The input device 102 transmits the image signals to the display panel 101 and controls the display panel 101 to display images. According to an embodiment of the invention, the electronic device 100 may be implemented as various devices, comprising: a mobile phone, a digital camera, a personal digital assistant (PDA), a lap-top computer, a personal computer, a television, an in-vehicle display, a portable DVD player, or any apparatus with image display functionality.

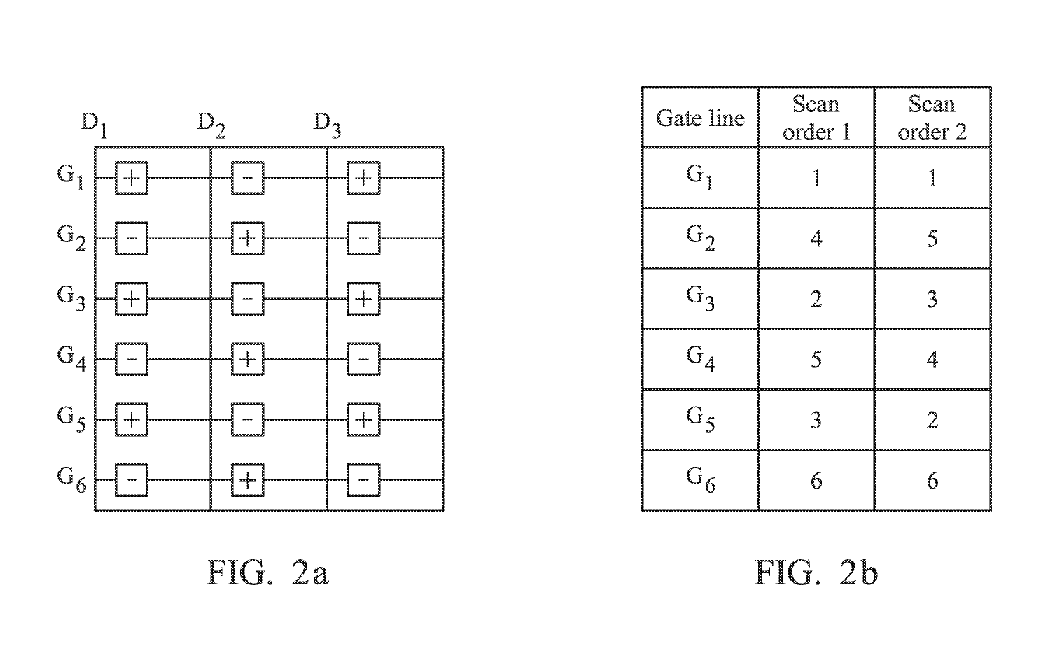

Liquid crystal display devices are generally driven by repeatedly inversing a polarity of a voltage applied across the liquid crystal unit. FIG. 2a and FIG. 2b respectively illustrates a concept of implementing line inversion driving technology according to an embodiment of the invention. FIG. 2a shows an exemplary spatial voltage polarity distribution of a 3×6 pixel array according to an embodiment of the invention. D₁˜D₃ represents the data lines, G₁˜G₆ represents the gate lines, an intersection of a data line and a gate line contains a pixel and the positive sign + and the negative sign − represents the voltage polarity. As shown in FIG. 2a, the voltage polarity is inverted once every pixel to appear as a dot inversion result when being inspected from a spatial perspective. Therefore, optimum display performance may be achieved.

However, when inspections occurs along the time axis, the voltage polarity of the data on each data line is actually inverted once every N lines, so as to solve the power consumption problem which usually happens when implementing the dot inversion. FIG. 2b shows two different exemplary gate line scan orders according to an embodiment of the invention. In the embodiment of the invention, the timing controller 140 may change the scan order of the gate lines so as to achieve N-line inversion (or N-row inversion) results. As shown in FIG. 2b, according to the scan order 1, the gate driving signals are sequentially applied to the gate lines G₁, G₃, G₅, G₂, G₄, G₆, so as to sequentially drive the pixels that electrically connect to the gate lines on a corresponding row and turn on the transistors on the corresponding rows. Therefore, based on the scan order 1, the polarities of the voltage sequentially transmitted on the data line D₁ are “+ + + − − −”, the polarities of the voltage sequentially transmitted on the data line D₂ are “− − − + + +” and the polarities of the voltage sequentially transmitted on the data line D₃ are “+ + + − − −”. In this case, N=3. For another example, according to the scan order 2, the gate driving signals are sequentially applied to the gate lines G₁, G₅, G₃, G₄, G₂, G₆, so as to sequentially drive the pixels that electrically connect to the gate lines on a corresponding row and turn on the transistors on the corresponding rows. Therefore, based on the scan order 2, the polarities of the voltage sequentially transmitted on the data line D₁ are “+ + + − − −”, the polarities of the voltage sequentially transmitted on the data line D₂ are “− − − + + +” and the polarities of the voltage sequentially transmitted on the data line D₃ are “+ + + − − −”. In this case, N=3.

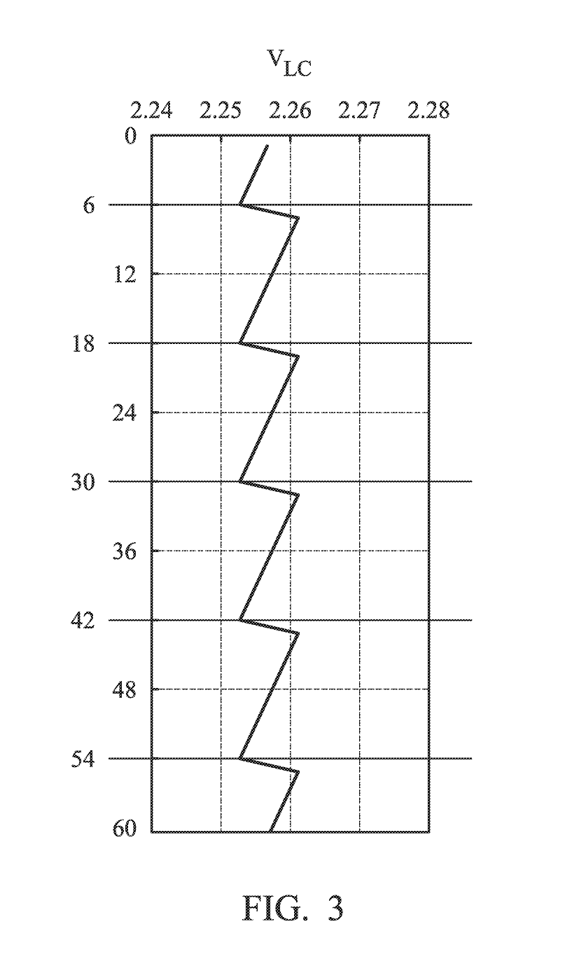

In the embodiments as illustrated above, although N-line inversion (or N-row inversion) is implemented when inspection occurs along the time axis, dot inversion results may be achieved. However, undesirable dark lines and bright lines may still occur due to the voltage drift caused when implementing N-line inversion, which is called the MURA effect. FIG. 3 shows the voltage drift results caused by N-line inversion, where the number on the X axis represents the cross voltage V_{LC} on the liquid crystal unit and the number on the Y axis represents the gate line scan order. Note that the scan order 1-60 as shown in FIG. 3 represents the 1^{st}-60^{th} sequentially turned on gate lines (that is, the 1^{st}-60^{th} gate lines to which the gate driving signals are sequentially applied), not the gate line indices.

In this example, the image to be displayed is a pure color image (such as, a blue color image), which has a constant pixel value. Therefore, the cross voltage V_{LC} originally applied onto each liquid crystal unit is a constant value, for example, 2.26 volt (V). Suppose that N=12, the timing controller inverses a voltage polarity of the data driving signals once every 12 data lines. When the polarity is inversed, a huge voltage drop or rise is generated when inverting from a positive voltage to a negative voltage or from a negative voltage to a positive voltage. The voltage drop or rise may cause the pixel voltage to drift via the coupling effect of the capacitor coupled between the data line and the pixel. As shown in FIG. 3, because the data line voltage polarity inversion occurs at the 7th, 19th, 31^{th}, 43^{th}, 55^{th} . . . conducted gate lines, the pixel voltage drift occurring on the 6^{th}, 18^{th}, 30^{th}, 42^{th}, 54^{th} . . . conducted gate lines are the most serious. Therefore, the cross voltage V_{LC} on the liquid crystal unit may finally diverge from 2.26V and may have a jagged distribution.

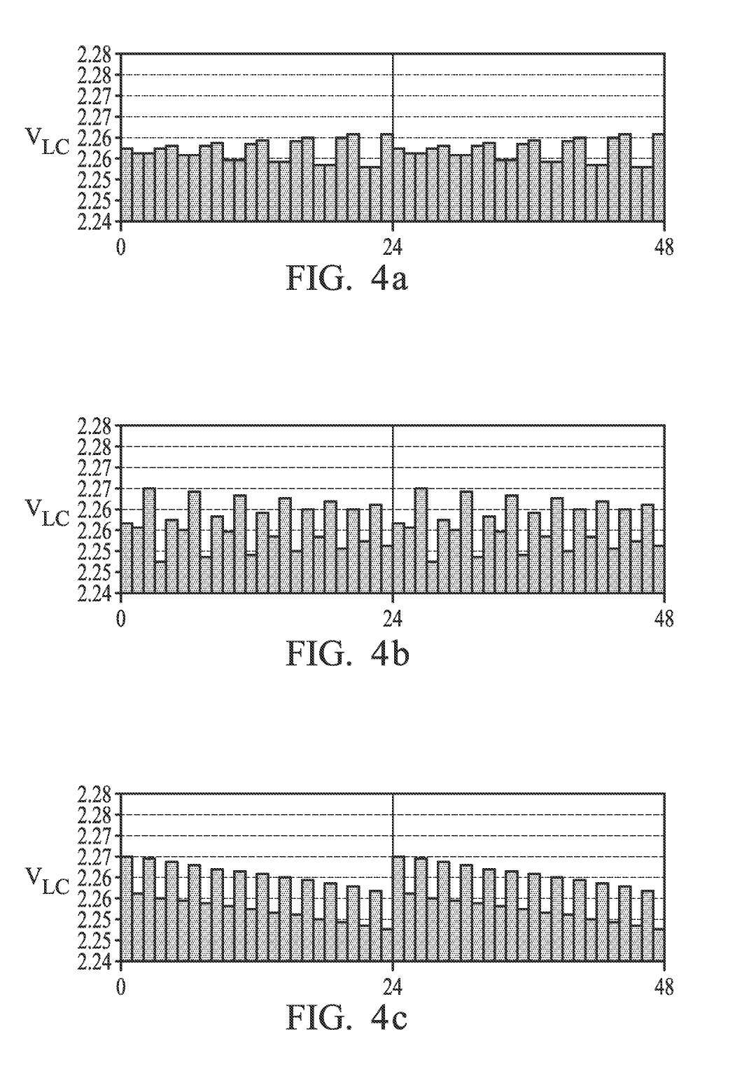

FIG. 4a˜4c shows different voltage distribution results caused by different scan orders according to an embodiment of the invention, where the number on the X axis represents the gate line index and the number on the Y axis represents the cross voltage V_{LC} of the liquid crystal unit. As described above, referring back to FIG. 2b, by arranging different scan orders, the same N-line inversion (or N-row inversion) results may be achieved. Therefore, in this embodiment, even if the scan order corresponding to FIG. 4a˜4c are different, the same 12-line inversion driving results as shown in FIG. 3 may still be achieved. Although the same 12-line inversion driving results are achieved, different voltage distribution results may be obtained for different scan orders, resulting in different locations of the dark lines and the bright lines. Therefore, different scan orders may cause different types of MURA effects. As shown in FIG. 4a, because the voltages on the 14^{th}, 15^{th}, 18^{th}, 19^{th}, 22^{th} and 23^{th} gate lines are relative low, obvious dark lines may be perceived By human eyes at the 14^{th}, 15^{th}, 18^{th}, 19^{th}, 22^{th} and 23^{th} _{lines.}

To solve the above-mentioned problems, several pixel value adjusting methods are illustrated in the following paragraphs for compensating for MURA effect caused by performing line inversion. Note that the proposed pixel value adjusting methods are applicable for any kind of line inversion design. In other words, no matter how the scan order is changed, the MURA effect caused by performing line inversion can be effectively compensated for based on the proposed pixel value adjusting methods.

According to an embodiment of the invention, after receiving the image signal from the host, the timing controller 140 may obtain the original pixel value of each pixel according to the image signal. Next, the timing controller 140 may adjust the original pixel value(s) of one or more pixel(s) according to a predetermined algorithm to generate one or more adjusted pixel value(s) and generate the data driving signals according to the original pixel values and the adjusted pixel value(s). In the embodiments of the invention, the timing controller 140 inverses a voltage polarity of the data driving signals once every N rows (where N is a positive integer and M is a total number of the rows on the pixel array, and 0<N<M). Therefore, in the embodiments of the invention, when inspection occurs along the time axis, the N-line inversion (or N-row inversion) driving method is applied to drive the display panel. By adjusting the original pixel value(s) of one or more pixel(s) according to the proposed predetermined algorithm, the MURA effect caused by performing line inversion may be effectively compensated for.

Note that in the embodiments of the invention, the above-mentioned pixel values may be, for example, the gray values of the image signal, and each pixel value may have a corresponding the pixel voltage. The data driving circuit transmits the data driving signals to the corresponding pixels so as to charge the capacitor in the pixels according to the pixel voltage and the liquid crystal unit displays. In addition, the liquid crystal unit displays images according to the voltage difference V_{LC} between the data driving signal and the common voltage signal. Because the voltage of the common voltage signal is usually a constant value (only the polarity is inversed), the above-mentioned pixel value, pixel voltage and data driving signals, which can also be represented by the voltage difference V_{LC}, actually have the same meaning. Therefore, although the above mentioned concept is to adjust the original pixel value of one or more pixels based on the predetermined algorithm, those who are skilled in this technology can still make various alterations and modifications without departing from the scope and spirit of this invention to apply the concept for adjusting the corresponding pixel voltage, data driving signal and the voltage difference V_{LC} of one or more pixels based on the predetermined algorithm, so as to compensate for MURA effect caused by performing line inversion. Therefore, the invention should not be limited to any specific way of implementation.

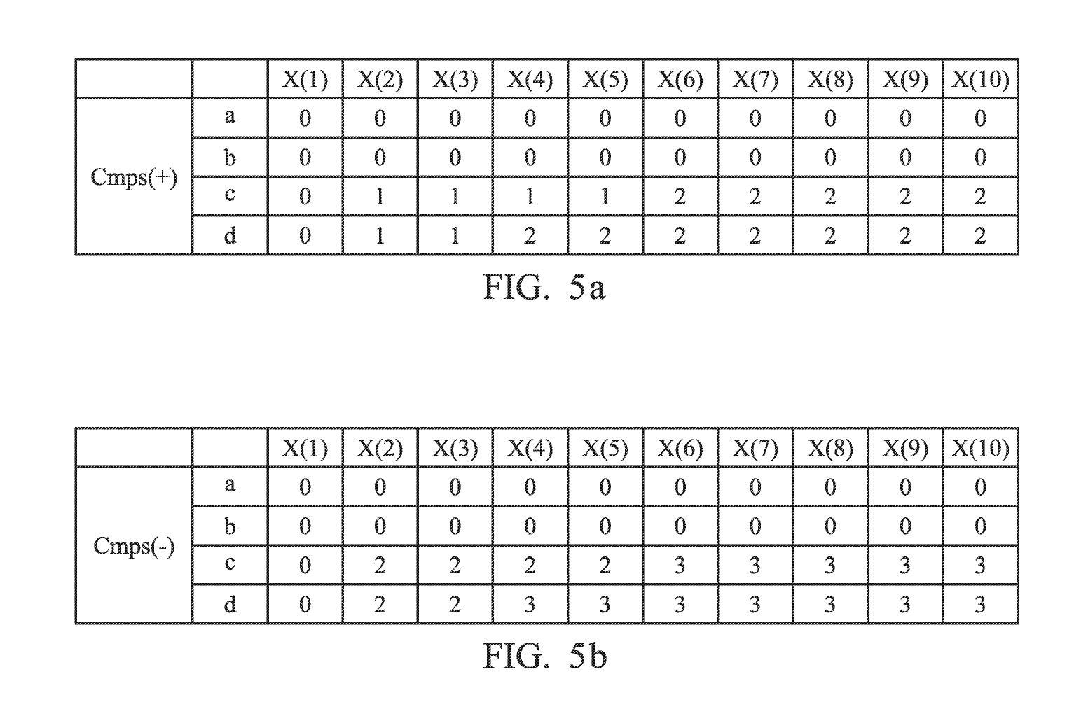

According to an embodiment of the invention, the timing controller 140 may store and maintain two compensation tables. For example, the timing controller 140 may comprise a look-up table (LUT) device for storing and maintaining two compensation tables. FIG. 5a and FIG. 5b respectively show the exemplary compensation table according to an embodiment of the invention. The two compensation tables may comprise L sets of compensation values, where L is a positive integer and 0<L<N. For example, as shown in FIG. 5a and FIG. 5b, the compensation tables Cmps(+) and Cmps(−) may respectively comprise four sets of compensation values, a, b, c and d. In addition, the timing controller 140 may set several threshold values, such as X(1)˜X(10), for providing different degrees of compensation according to the pixel value difference. The proposed compensation algorithm will be further illustrated in the following paragraphs.

According to the proposed compensation algorithm, the timing controller 140 may first determine which set of the L sets of compensation values is to be used according to the scan order of an R^{th} row in which a pixel n lies, where n and R are positive integers and n is smaller than a total number of the pixels in the pixel array and R is smaller than the total number of rows M. Suppose that N=12, the timing controller 140 may inverse the voltage polarity once every 12 lines. When the timing controller 140 determines that the R-th row having the pixel n lying therein is the 10^{th}-12^{th} scanned row when performing the 12-row inversion (that is, in the three rows that are closest to a next polarity inversion), it means that the pixel n may possibly suffer from the most serious degree of voltage drift possible. Therefore, the timing controller 140 may choose the set compensation value for performing the pixel value compensation. When the timing controller 140 determines that the R-th row having the pixel n lying therein is the 1^{st}-3^{rd} scanned row when performing the 12-row inversion (that is, in the three rows that are furthest away from a next polarity inversion), it means that the pixel n may possibly suffer from the least serious degree of voltage drift possible. Therefore, the timing controller 140 may choose the ‘a’ set compensation value for performing the pixel value compensation. When the timing controller 140 determines that the R-th row having the pixel n lying therein is the 4^{th}-6^{th} or the 7^{th}-9^{th} scanned row when performing the 12-row inversion, the timing controller 140 may choose the ‘b’ or ‘c’ set compensation value for performing the pixel value compensation. As shown in FIG. 5a and FIG. 5b, the set ‘a’ comprises the smallest compensation values and the set ‘d’ comprises the greatest compensation values.

After determining which set of compensation values is to be used, the timing controller 140 may further determine a relationship between the original pixel value D(n) of the pixel n and the original pixel value D(n+1) of an adjacent pixel (n+1). If the original pixel value D(n) of the pixel n equals to the original pixel value D(n+1) of the adjacent pixel (n+1), or when a difference |D(n+1)−D(n) between the pixel values D(n) and D(n+1) exceeds a predetermined value, the timing controller 140 may determine not to adjust the pixel value D(n) of the pixel n. According to an embodiment of the invention, the predetermined value may be set to, for example, a gray value 128, which is half of the maximum gray value 256. According to an embodiment of the invention, a data line connected to the adjacent pixel (n+1) may be a next data line of the one which the pixel n is connected to, and the pixel n and the adjacent pixel (n+1) may be connected to the same gate line. For example, an adjacent pixel of the pixel on the intersection of the data line D₂ and the gate line G₃ in FIG. 2a is the pixel on the intersection of the data line D₃ and the gate line G₃.

If the original pixel value D(n) of the pixel n does not equal to the original pixel value D(n+1) of the adjacent pixel (n+1) and the difference |D(n+1)−D(n)| between the pixel values D(n) and D(n+1) does not exceed the predetermined value, the timing controller 140 may further determine whether the original pixel value D(n) of the pixel n is greater than the original pixel value D(n+1) of the adjacent pixel (n+1). When D(n)>D(n+1), the timing controller 140 may determine between which two threshold values the difference [D(n)−D(n+1)] lies. According to an embodiment of the invention, the values of X(1)˜X(10) may be chosen from the pixel values 0-128. For example, X(1)=1, X(2)=11, X(3)=22, X(4)=34, X(5)=48, X(6)=62, X(7)=76, X(8)=90, X(9)=105 and X(10)=128.

Suppose that X(i)≦[D(n)−D(n+1)]<X(i+1), where i is a positive integer and i=1˜10, the timing controller 140 may choose a compensation value Z corresponding to X(i) from the a˜d sets of compensation values in the compensation table Cmps(+), and use the compensation value Z to adjust the original pixel value D(n) to obtain the adjusted pixel value D′(n)=D(n)+Z. For example, suppose that [D(n)−D(n+1)]=100, then it is determined that i=8. When the pixel n lies in the 12^{th} scanned row when performing the 12-row inversion, the timing controller 140 may obtain the compensation value Z=2 corresponding to the threshold value X(8) from the set compensation value in the compensation table Cmps(+). Thus, the adjusted pixel value D′(n)=D(n)+2.

On the other hand, when D(n+1)>D(n), the timing controller 140 may determine between which two threshold values of the threshold values X(1)˜X(10) the difference between [D(n+1)−D(n))] lies. Suppose that X(i)≦[D(n+1)−D(n)]<X(i+1), the timing controller 140 may choose a compensation value Z corresponding to X(i) from the a˜d sets of compensation values in the compensation table Cmps(−), and use the compensation value Z to adjust the original pixel value D(n) to obtain the adjusted pixel value D′(n)=D(n)+Z. For example, suppose that [D(n+1)−D(n)]=50, then it is determined that i=5. When the pixel n lies in the 1^{st} scanned row when performing the 12-row inversion, the timing controller 140 may obtain the compensation value Z=0 corresponding to the threshold value X(5) from the ‘a’ set compensation value in the compensation table Cmps(−). Thus, the adjusted pixel value D′(n)=D(n)+0.

Note that the compensation values in the compensation tables Cmps(+) and Cmps(−) as shown in FIG. 5a and FIG. 5b are mere examples and the invention should not be limited thereto. The proposed image display system may adjust the compensation values in the compensation tables Cmps(+) and Cmps(−) according to different compensation requirements to achieve optimum compensation results.

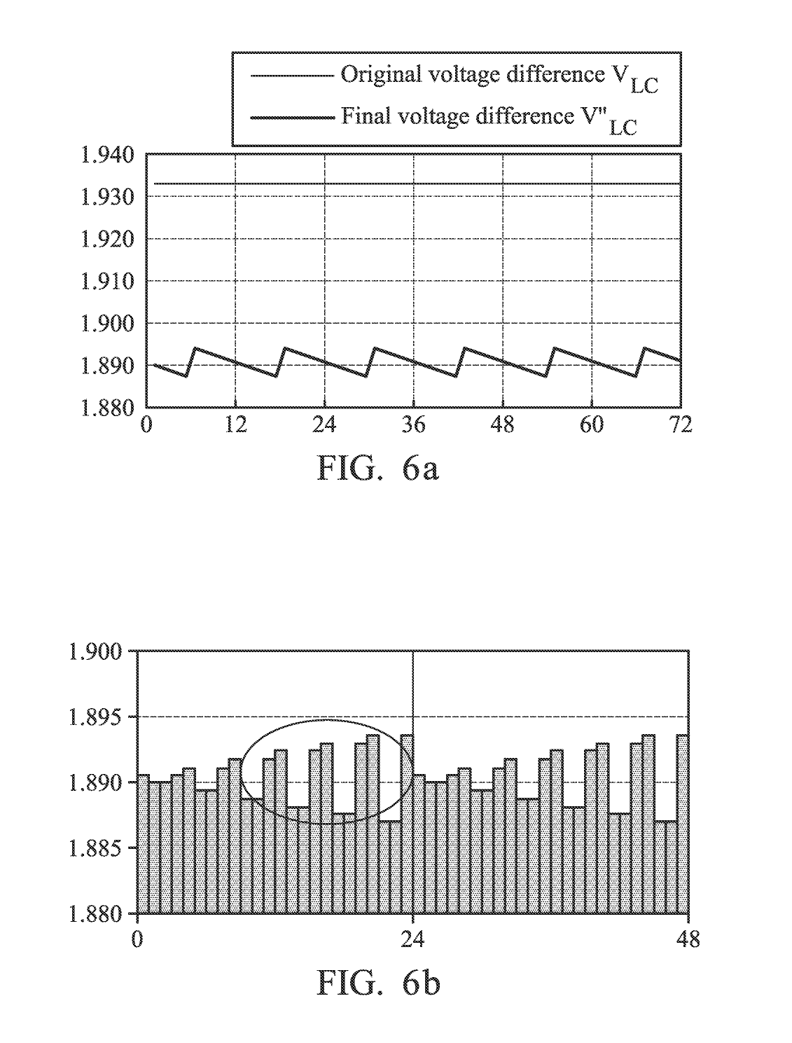

FIG. 6a is a diagram showing an original voltage difference V_{LC} and the final voltage difference V″_{LC} on a data line without compensating for MURA effect, where the number on the X axis represents the gate line scan order and the number on the Y axis represents the voltage difference of each pixel on a data line. FIG. 6b is a diagram showing voltage distribution on a data line without compensating for MURA effect, where the number on the X axis represents the gate line index and the number on the Y axis represents the voltage difference V″_{LC} of each pixel on a data line. As shown in FIG. 6a, suppose that the image to be displayed is a pure color image, the original voltage difference V_{LC} should be a constant value. However, because the voltage drop or rise generated when performing the polarity inversion may cause the pixel voltage to drift, the final voltage difference V″_{LC} may diverge from the original voltage difference and may have a jagged distribution. The voltage drift may finally cause several obvious dark lines, as marked with a circle in FIG. 6b, which is generated when displaying the pure color image.

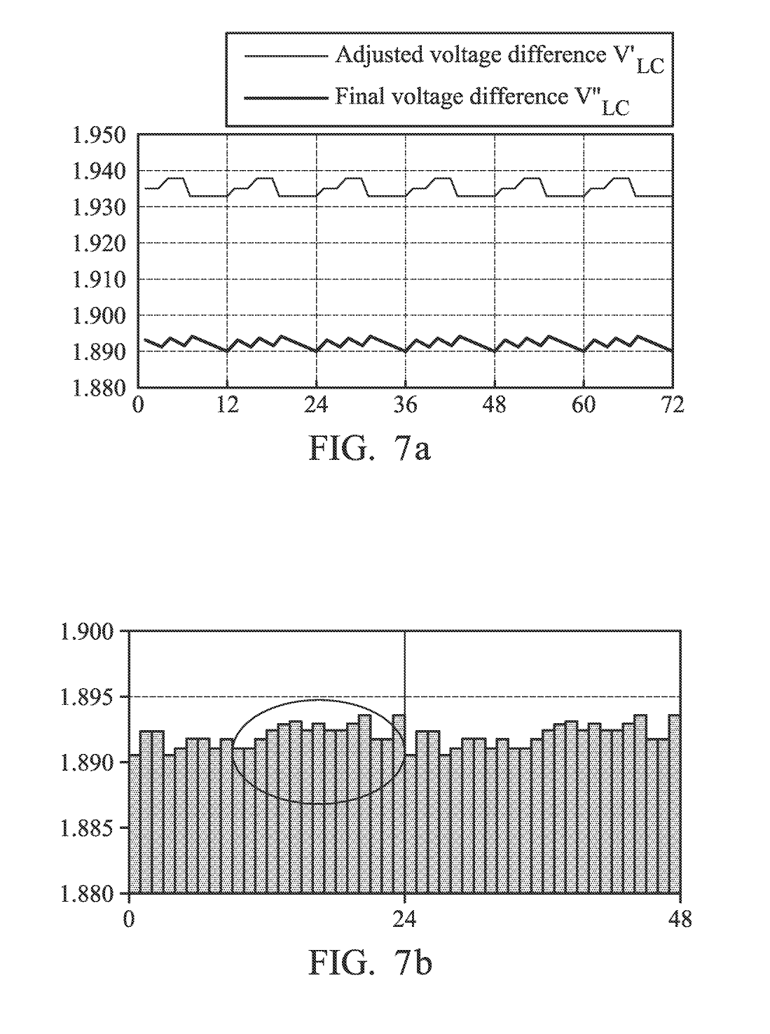

FIG. 7a is a diagram showing adjusting of a voltage difference V′_{LC} and the final voltage difference V″_{LC} on a data line after compensating for MURA effect according to an embodiment of the invention, where the number on the X axis represents the gate line scan order and the number on the Y axis represents the voltage difference of each pixel on a data line. FIG. 7b is a diagram showing voltage distribution on a data line after compensating for MURA effect according to an embodiment of the invention, where the number on the X axis represents the gate line index and the number on the Y axis represents the voltage difference V″_{LC} of each pixel on a data line. As shown in FIG. 7a, the timing controller 140 may adjust the original voltage difference V_{LC} in a way which is contrary to the voltage drift that may possibly happen after line inversion, thus obtaining the adjusted voltage difference V′_{LC}. In this manner, after compensation, the voltage drift on the final voltage difference V″_{LC} may be eased and, as shown in FIG. 7b, there may no longer be any obvious dark lines generated on the displayed image.

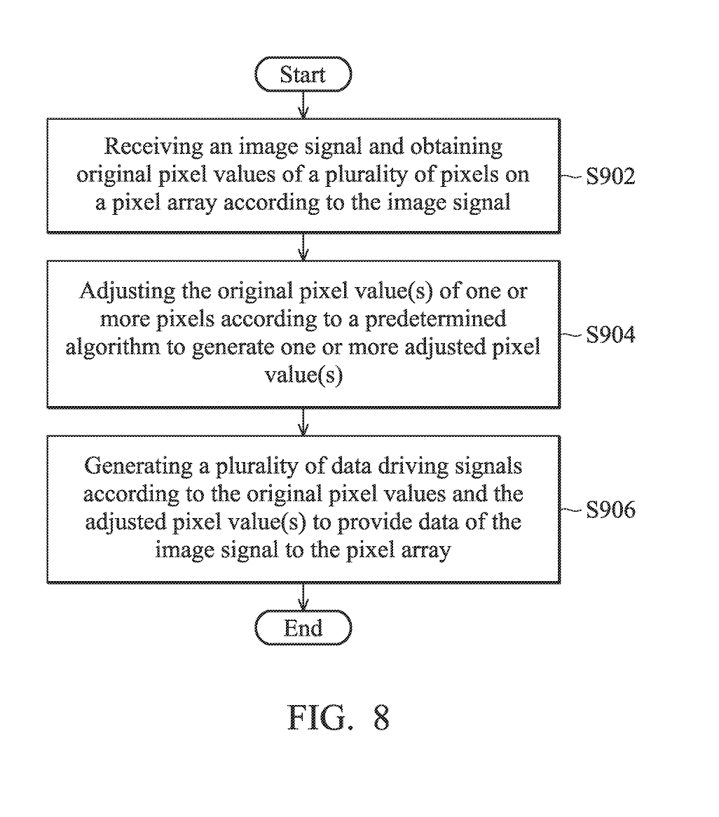

FIG. 8 shows a flow chart of a pixel value adjusting method for compensating for MURA effect caused by performing line inversion according to an embodiment of the invention. The timing controller first receives an image signal and obtains original pixel values of a plurality of pixels on a pixel array according to the image signal (Step S902). Next, the timing controller adjusts the original pixel value(s) of one or more pixels according to a predetermined algorithm to generate one or more adjusted pixel value(s) (Step S904). Based on the predetermined algorithm, the original pixel value of one pixel is adjusted according to a difference between the original pixel value of the pixel and the original pixel value of an adjacent pixel. Finally, the timing controller generates a plurality of data driving signals according to the original pixel values and the adjusted pixel value(s) to provide data of the image signal to the pixel array (Step S906).

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An image display system, comprising:
a data driving circuit, outputting a plurality of data driving signals to provide data of an image signal to a plurality of pixels on a pixel array; and
a timing controller, obtaining original pixel values of the pixels according to the image signal, adjusting the original pixel value(s) of one or more pixel(s) according to a predetermined algorithm to generate one or more adjusted pixel value(s), and generating the data driving signals according to the original pixel values and the adjusted pixel value(s),
wherein based on the predetermined algorithm, the original pixel value of one pixel is adjusted according to a difference between the original pixel value of the pixel and the original pixel value of an adjacent pixel.

2. The image display system as claimed in claim 1, further comprising a display panel, wherein the display panel comprises:
the pixel array, comprising the pixels; and
a gate driving circuit, outputting a plurality of gate driving signals to drive the pixels on the pixel array.

3. The image display system as claimed in claim 1, wherein when the difference equals to zero or exceeds half of the maximum gray value, the timing controller does not adjust the original pixel value of the pixel.

4. The image display system as claimed in claim 1, wherein the predetermined algorithm is defined such that when the original pixel value of the pixel exceeds the original pixel value of the adjacent pixel, the timing controller obtains a first compensation value according to a first compensation table and the difference, and adjusts the original pixel value of the pixel according to the first compensation value to generate the adjusted pixel value, and when the original pixel value of the pixel is obtains a second compensation value according to a second compensation table and the difference, and adjusts the original pixel value of the pixel according to the second compensation value to generate the adjusted pixel value.

5. The image display system as claimed in claim 1, wherein the timing controller inverses a voltage polarity of the data driving signals once every N rows, wherein N is a positive integer and M is a number of the rows on the pixel array, and 0<N<M.

6. The image display system as claimed in claim 5, wherein the timing controller further stores a first compensation table and a second compensation table, and the first compensation table and the second compensation table respectively comprises L sets of compensation values, wherein L is a positive integer and 0<L<N, and when the original pixel value of the pixel exceeds that of the original pixel value of the adjacent pixel, the timing controller obtains a first set of compensation values from the L sets of compensation values in the first compensation table according to an index of a row in which the pixel lies, and obtains a first compensation value from the first set of compensation values according to the difference, and adjusts the original pixel value of the pixel according to the first compensation value to generate the adjusted pixel value.

7. The image display system as claimed in claim 6, wherein when the original pixel value of the pixel is smaller than the original pixel value of the adjacent pixel, the timing controller obtains a second set of compensation values from the L sets of compensation values in the second compensation table according to the index of the row in which the pixel lies, and obtains a second compensation value from the second set of compensation values according to the difference, and adjusts the original pixel value of the pixel according to the second compensation value to generate the adjusted pixel value.

8. A pixel value adjusting method for compensating for MURA effect caused by performing line inversion, comprising:
receiving an image signal and obtaining original pixel values of a plurality of pixels on a pixel array according to the image signal;
adjusting the original pixel value(s) of one or more pixels according to a predetermined algorithm to generate one or more adjusted pixel value(s); and
generating a plurality of data driving signals according to the original pixel values and the adjusted pixel value(s) to provide data of the image signal to the pixel array,
wherein a voltage polarity of the data driving signals is inverted once every N rows, and wherein 0<N<M, N is a positive integer and M is a number of the rows on the pixel array, and
wherein based on the predetermined algorithm, the original pixel value of one pixel is adjusted according to a difference between the original pixel value of the pixel and the original pixel value of an adjacent pixel.

9. The pixel value adjusting method as claimed in claim 8, further comprising:
not adjusting the original pixel value of the pixel when the difference equals to zero or exceeds a predetermined value.

10. The pixel value adjusting method as claimed in claim 8, further comprising:
maintaining a first compensation table and a second compensation table, wherein the first compensation table and the second compensation table respectively comprises L sets of compensation values, wherein L is a positive integer and 0<L<N;
when the original pixel value of the pixel exceeds the original pixel value of the adjacent pixel,
obtaining a first set of compensation values from the L sets of compensation values in the first compensation table according to an index of a row in which the pixel lies,
obtaining a first compensation value from the first set of compensation values according to the difference; and
adjusting the original pixel value of the pixel according to the first compensation value to generate the adjusted pixel value.

11. The pixel value adjusting method as claimed in claim 10, further comprising:
when the original pixel value of the pixel is smaller than the original pixel value of the adjacent pixel,
obtaining a second set of compensation values from the L sets of compensation values in the second compensation table according to an index of a row in which the pixel lies,
obtaining a second compensation value from the second set of compensation values according to the difference; and
adjusting the original pixel value of the pixel according to the second Compensation value to generate the adjusted pixel value.
